(19) United States
(12) Patent Application Publication
(10) Pub. No.: US 2020/0110895 A1
(43) Pub. Date: Apr. 9, 2020

(54) SOCIAL POST MANAGEMENT BASED ON SECURITY CONSIDERATIONS

(71) Applicant: International Business Machines Corporation, Armonk, NY (US)

(72) Inventors: Al Chakra, Apex, NC (US); Faisal Ghaffar, Dunboyne (IE); Ahmad Abdul Wakeel, Mulhuddart (IE); Kevin Carr, Raleigh, NC (US)

(21) Appl. No.: 16/150,302

(22) Filed: Oct. 3, 2018

(51) Int. Cl. G06F 21/62; H04L 29/08; G06Q 50/00

(52) U.S. Cl. CPC G06F 21/6245; G06Q 50/01; H04L 67/22

(57) ABSTRACT

Provided are embodiments for a social post management technique based on security considerations. The technique includes monitoring content of one or more messages of at least one social media platform, identifying personal information from the content of the one or more messages, and receiving risk analytics information associated with the content of the one or more messages. The technique also includes correlating the identified personal information and the risk analytics information, calculating a vulnerability score based on the correlation of the identified personal information and the risk analytics information, and transmitting a notification to a user, the notification comprises the vulnerability score.

### BACKGROUND

The present invention generally relates to social networking systems, and more specifically to the management of social posts based on security considerations.

Social media platforms allow users to interact with other members that have like interests or associations. Users are able to share media, files, and other content over the social media network. In addition, users are able to publish posts with varying levels of privacy. For example, posts can be limited to only the group members, or in another example, the posts can be limited to friends of the user publishing the post. There may be a need to manage the posts that are published by the user or related to the user.

### SUMMARY

Embodiments of the present invention are directed to a computer-implemented method for social post management of security considerations. A non-limiting example of the computer-implemented method includes monitoring content of one or more messages of at least one social media platform, and identifying personal information from the content of the one or more messages. The computer-implemented method also includes receiving risk analytics information associated with the content of the one or more messages, and correlating the identified personal information and the risk analytics information. The computer-implemented method includes calculating a vulnerability score based on the correlation of the identified personal information and the risk analytics information, and transmitting a notification to a user, the notification comprises the vulnerability score.

Embodiments of the invention are directed to a computer program product for social post management of security considerations, the computer program product comprising a computer-readable storage medium having program instructions embodied therewith. The program instructions are executable by a processor to cause the processor to perform a method. A non-limiting example of the method includes monitoring content of one or more messages of at least one social media platform, and identifying personal information from the content of the one or more messages. The method also includes receiving risk analytics information associated with the content of the one or more messages, and correlating the identified personal information and the risk analytics information. The method includes calculating a vulnerability score based on the correlation of the identified personal information and the risk analytics information, and transmitting a notification to a user, the notification comprises the vulnerability score.

Embodiments of the present invention are directed to a system for social post management of security considerations. A non-limiting example of the system includes a vulnerability score engine, a pre-post warning component, and a storage medium, the storage medium being coupled to a processor. The processor is configured to monitor content of one or more messages of at least one social media platform, identify personal information from the content of the one or more messages, and receive risk analytics information associated with the content of the one or more messages. The processor is also configured to correlate the identified personal information and the risk analytics information, calculate a vulnerability score based on the correlation of the identified personal information and the risk analytics information, and transmit a notification to a user, the notification comprises the vulnerability score based at least in part on a configurable threshold for the vulnerability score.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating one example of a processing system for practice of the teachings herein;

FIG. 2 depicts a system for social post management based on security considerations in accordance with one or more embodiments of the invention;

FIG. 3 depicts another system for social post management based on security considerations in accordance with one or more embodiments of the invention;

FIG. 4 depicts a flowchart of a method for social post management based on security considerations in accordance with one or more embodiments of the invention; and

FIG. 5 depicts a computer program product in accordance with one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, various social network platforms allow users to maintain and update profiles. The users are also allowed to publish posts and status updates to various groups or generally to the social media network. Users are also allowed to form groups within the social network to restrict access to those members of the group. Generally, members of the group have shared interests or acquaintances.

Oftentimes, the data that is posted on a social media network can be made available to those that are not part of the social network or the information can be published outside of the social network. This can lead to the user's personal information being exposed such as the user's current location, future location, future travel plans, etc. It should be understood that personal information is not limited to the example listed above but can also include information such as the name, age, photo of the individual, etc. Because much of the data presented on social media platforms are not limited to group members there may be a need to inform the user of a potential risk related to publishing the post before the user publishes the post.

The techniques described herein provide a method and system to inform the user of a potential risk of a post based on the personal content of a post being correlated to a risk analytics information associated with the personal information of the post. In one or more embodiments of the invention, the risk analytics data can include information related to a crime such as a type of crime (risk event), the location and time information associated with the crime, a history of the crime occurring, etc.

Turning now to an overview of the aspects of the invention, one or more embodiments of the invention address the above-described shortcomings of the prior art by providing techniques to correlate personal information of a message or social media post with risk analytics to generate a vulnerability score. The score is then provided to the user prior to publishing a post to warn the user of the amount of exposure of the personal information.

The above-described aspects of the invention address the shortcomings of the prior art by allowing a user the opportunity to avoid publishing the personal information or automatically hide personal information of the user in a post published by another user. Responsive to the analyzer detecting posts related to a user ID or tag of a given user, the analyzer can be configured to remove the tag, prompt the other user that user confirmation is required, or remove the post. In one or more embodiments of the invention, users are allowed to set their privacy settings to allow others to “tag” their user ID in a post or the user can selectively choose whether to allow the post to be published after their review. The user can be notified of the warning and make a decision as to whether to allow the personal information to be posted or not, which can increase the safety of the user.

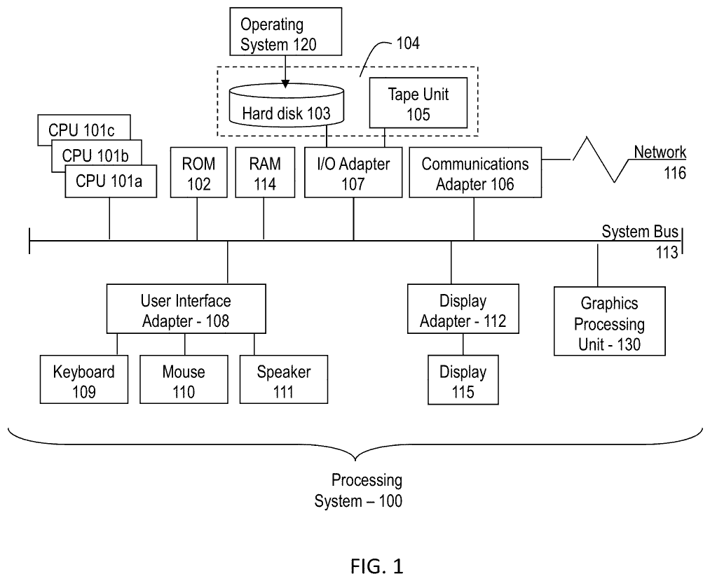

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

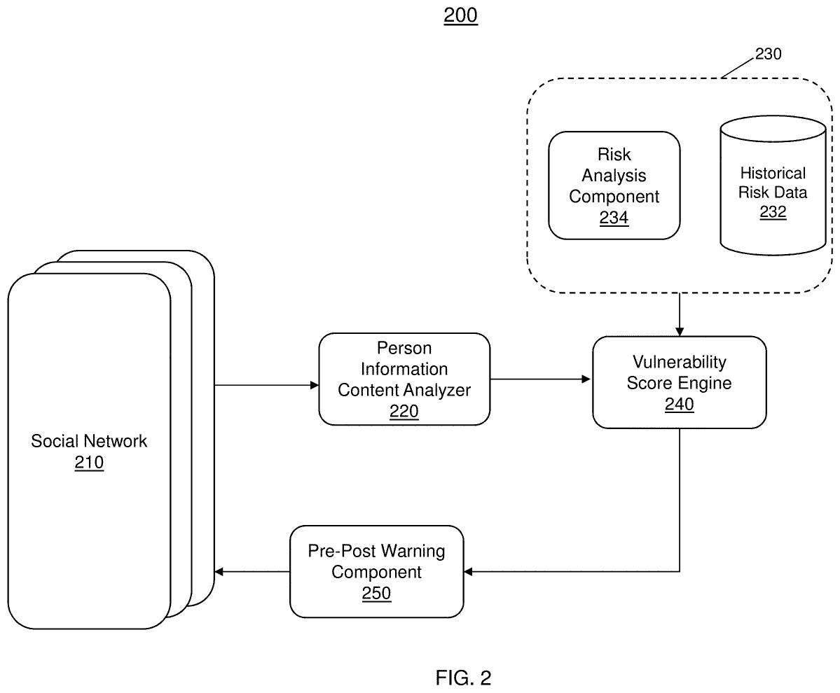

FIG. 2 depicts a system 200 in accordance with one or more embodiments of the invention. In embodiments of the invention, the system 200 is configured to generate notifications of a vulnerability level for a social media user prior to publishing posts by associating the contextual reference information of a social media post with risk analytics information. FIG. 2 also depicts social network platform(s) 210 of which a user may be a member. The social network platforms 210 allow users to publish posts, status updates and interact with the social network community in other ways.

FIG. 2 depicts a personal information content analyzer 220 (hereinafter referred to as “analyzer 220”) that is configured to identify the personal information of a message or post. In one or more embodiments of the invention, the analyzer 220 can identify the personal information by filtering the text of the message or post and matching the text with terms indicated as personal information such as location information. The text that is analyzed can be posted in social media platform such as on a user's “wall” (a message board) or status and can filter the text of the post to analyze the data. In other applications, the analyzer 220 can be used to filter the personal information of texts when a user is sending other types of messages such as direct messages, email, etc. In addition, the analyzer 220 can analyze the user's public profile information to determine the amount of personal information is revealed including but not limited to the user's age, hometown, employer, etc.

For example, the analyzer 220, by monitoring and filtering the data posted by a user, can identify check-in data from the social media platform, location information, venue names, travel route information, etc. The analyzer 220 can be configured by an administrator or other technique to search the posts, profiles, etc. for check-in data. In some social media platforms a check-in function is provided so that users can share their location. This function can identify the check-in function. It should be understood that the analyzer 220 can be updated as new social media functions or keywords are developed. The analyzer 220 can also be configured to determine a user identifier or “tag” information where another user has tagged the user in a post, media, or another type of content on the social network by monitoring the tag that is associated with the user. Responsive to identifying the posts that have been associated with the user, the analyzer 220 can filter through the post to detect whether any personal information is present in the post.

In a non-limiting example, a user may post check-in information that can indicate the user is located at a particular hotel on vacation. It is normal for a post to include time information and/or location information. This can indicate that a user is away from their home and how far away from home the user is. In addition, this information can indicate the current location of the user. In another post, the user may indicate future dinner plans at a particular destination or their current location is at a retail establishment or another place. A route can be established between the location of the first post and the location of the second post. This can provide an indication that the user is away from their hotel and potentially a duration the user will be away, a travel path, a possible return travel path, etc.

In one or more embodiments of the invention, the analyzer 220 can be manually configured with keywords to indicate the personal information of a user message and/or post. In one or more embodiments of the invention, an administrator or user can input various settings through an API to manually configure the keywords associated with the personal information. In one or more embodiments of the invention, machine-learning techniques can be used to develop the keywords that are filtered by the analyzer 220 to determine personal information.

The personal information determined from the post(s) can be correlated with information from a risk analytics system 230. The risk analytics system 230 can be configured to determine patterns of crimes or various risk events that can be used to predict factors that yield a higher probability of a crime occurring. For example, the crimes that have occurred over a period of time can be analyzed. The risk analytics system 230 is configured to maintain data associated with various risk events such as location information, time information, a risk score, risk factors, etc. in a historical risk database 232. The risk analytics information can be managed and entered by an administrator. For example, a crime or risk event can include a robbery, assault, or another event. The location information can include map information, GPS coordinate data, a venue name, street intersection, etc. A risk score can be calculated by the risk analysis component 234. The risk score is derived from one or more risk factors. For example, the risk score can be a probability of a risk event occurring, such as taking the historic data for an event over a period of time (week, month, year). By determining a number of times an event has occurred over a period of time a probability of the event occurring can be determined. The risk factors can include information such as broken street lights, time of year (fall, winter, spring, and summer), time of day, an occupied area. The time of year can indicate when more people will be outdoors. For example, during spring and summer months more users may be outside compared to the cooler winter months. In one or more embodiments of the invention, the factors can be weighted based on how close the factor is to the target.

For example, the location information based on a time period that matches a record from the risk analytics system 230 yielding a higher probability of an occurrence of an event will have a higher score. On the other hand, as the time period is further away from a time period or location of an event from the risk analytics system 230.

In one or more embodiments of the invention, the vulnerability score engine 240 is configured to determine a contextual reference from the personal information and comparing the contextual reference information to the information from the risk analytics system 230 to calculate a vulnerability score. The vulnerability score is proportional to the association between content in the post and the factors associated with a particular crime.

The contextual reference data provided from the content of the social network message and/or post can indicate a location of the user. The contextual reference information can also indicate time information that may reveal the user's location. The location can include information indicating a past location, current location and/or future location. The location information can also provide information indicating one or more routes from a current location to a target destination. The time period between a first post and subsequent post(s) can be used to determine the contextual reference information. In addition, the time information such as tonight, tomorrow, etc. that is included in the content of the post can be used to determine a contextual reference.

In one or more embodiments of the invention, the engine 240 is configured to receive information from the analyzer 220 and the risk analytics system 230. The data from the analyzer 220 is correlated to the information of the risk analytics system 230 to calculate a vulnerability score. For example, if the data filtered by the analyzer 220 matches the data from the risk analytics system 230, the vulnerability score can be incremented. For example, in the event the user post they are going to dinner at a particular time is associated with a risk event such as a robbery during the evening hours, the information can be searched in the risk analytics database to determine a history of events that have occurred. If the event occurs at the particular location a higher score can be provided. If the event occurs at a location within proximity of the dinner location a lower score is provided. Similarly, if the event historically occurs during the same period of time as the planned dinner time, a higher score can be provided. However, if the event occurs at a time different from the planned dinner time a lower score can be provided as historically the event does not occur at the time of the planned dinner at the location.

In addition, the engine 240 is configured to analyze data from a plurality of social network platforms. For example, a user can post data on a first social media platform and post data on a second social media platform.

The vulnerability score correlates the crime analytics data and personal information data. Techniques involve linking records from the crime analytics data with data from the previous posts to generate the vulnerability score. In one or more embodiments of the invention, the vulnerability warning level is the vulnerability score of the post multiplied by the level of personal information exposure about a particular user. The personal information can be exposed by a post by the user or by another user. In addition, the personal information can be determined across multiple social media platforms.

FIG. 2 also depicts a pre-post warning component 250 configured to provide a warning to the user before the user publishes the post. In one or more embodiments of the invention, the vulnerability warning or risk level can be on a scale from 1-10 where 10 is the highest level indicating the most risk and 1 indicates a low risk. It should be understood that other scales can be used such as scales from 1-100 or others.

In other embodiments of the invention, the notification can indicate a risk level based on a color scheme or other visual notification. The notification can also be provided to a user through haptic feedback including various vibrations patterns that can be configured to provide an indication of a level of risk. Also, various audio notifications can be provided to the user. It should also be understood that any combinations of the features, including those mentioned above and not mentioned above, can be used.

In one or more embodiments of the invention, the notification can be provided to the user based on the vulnerability score of the message exceeding a configurable threshold. In the event the configurable threshold is not reached, no warning may be provided to the user. On the other hand, if the configurable threshold is exceeded a warning can be provided to the user. The warning can indicate the vulnerability score and also a risk event that is associated with the vulnerability score.

In addition, multiple configurable thresholds can be used to provide various levels of warnings to the user. For example, a first threshold level can indicate a low risk based on the determined vulnerability score, a second threshold level can indicate a medium risk, and a third threshold level can indicate a high risk. It should be understood that a different number of thresholds and different intensity of risks can be used. In one or more embodiments of the invention, the notification is provided to the user using a user interface of a user device such as a computing device, tablet, mobile device, etc.

In a scenario where the personal information of a user is already posted on one or more social networks, and the crime analytics related to the user's location or other contextual reference information associated with the user is updated causing a recalculation of the vulnerability score to become high or exceed a configurable threshold for the existing post, the post can be automatically hidden. In one or more embodiments of the invention, the user can be notified of the automatically hidden post.

In a different scenario, if a group member or a social network user that is associated with a current user that has shared information related to the current user and a calculation of the vulnerability score results in a high vulnerability score, a warning can be provided to the user to request permission to allow the post to be published and/or made public. For example, in the event a friend of a current user shares a post, where the post includes a tag for the current user, the analyzer 220 can filter through the texts of the post for keywords that can expose personal data of the current user. If the identified personal information results in a high vulnerability score, the warning or notification can be sent to the current user. The high score can be determined according to a configurable threshold where the threshold is based on an average of vulnerability scores.

In one or more embodiments of the invention, the user can configure a threshold warning level to take various actions. For example, the actions can include automatically hiding the post. In a different example, the actions can include hiding portions of content in the post as opposed to hiding the complete post.

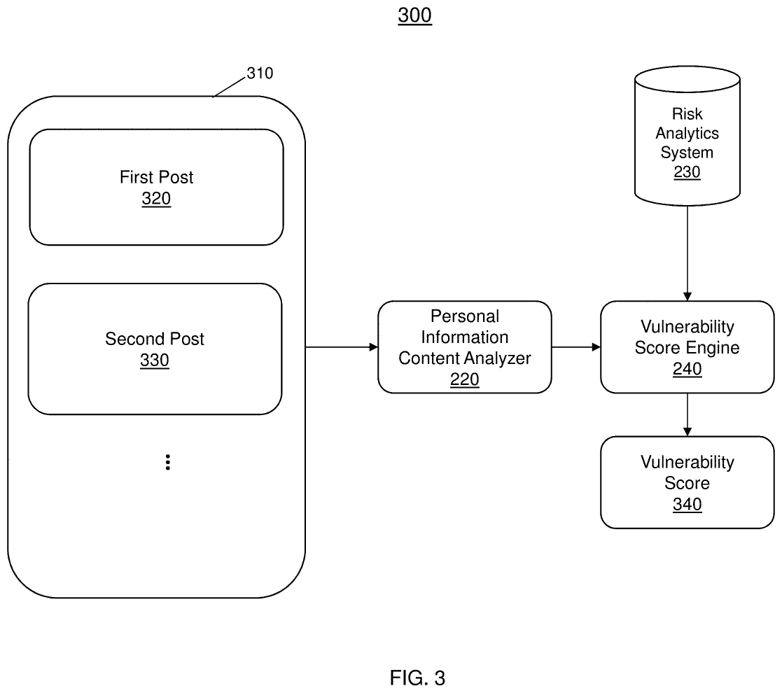

FIG. 3 depicts a system 300 for social post management based on security considerations in accordance with one or more embodiments of the invention. In this non-limiting example, the first post 320 of the social media platform 310 indicates a user has checked-in to the hotel at a location “X” at a specific time.

The second post 330 indicates the user is leaving for dinner in an hour at a restaurant at location “Y.” In one or more embodiments of the invention, the user has not yet published the post as the system 300 analyzed the post. The analyzer 220 parses the first post and the second post to determine the personal information related to the posts. In this example, the personal information includes the location “X” of the hotel and the location “Y” of the restaurant and time information indicating the time of the dinner. The engine 240 receives this information and correlates the information from the risk analytics system 230 associated with the personal information of the posts. In other words, the engine 240 filters the through the post to find personal information and determines whether any matching information regarded as personal information is present in the post. In addition, the engine 240 can determine a route between the location “X” and location “Y” and correlate any risks that may be related to between the personal information and the risk analytics information. It should be understood that other posts can be analyzed and correlated to the risk analytics information to generate a score for the posts, where the posts can originate from the same and/or different social media platforms.

The engine 240 is configured to generate a score and transmit the vulnerability score 340 and the risk analytics information to the user. The score is generated by analyzing data of a post that is associated with the user, which can either be posted on the user's wall or tagged in a post by another user. For example, the text of the post and/or an image of the user can be used to identify a user. Responsive to identifying the user in a post, the text of the post can be filtered to identify personal information. In one or more embodiments of the invention, the user can determine whether the post should be published based on the received notification.

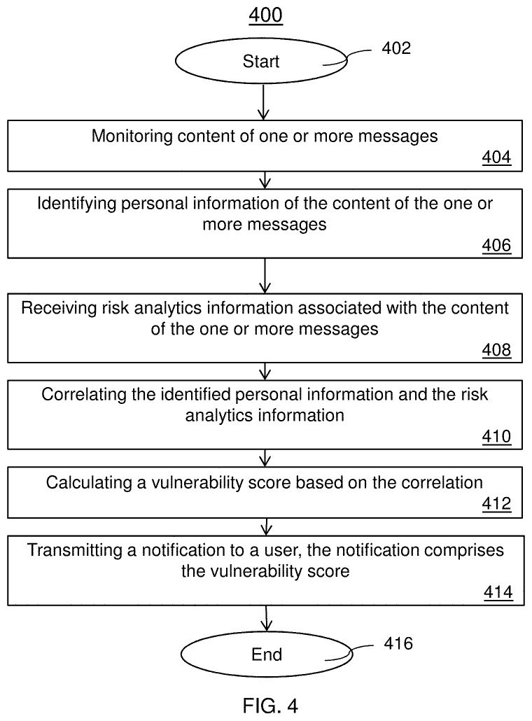

Now referring to FIG. 4, a flowchart of a method 400 for the management of social posts based on security considerations in accordance with one or more embodiments is shown. The method 400 begins at block 402 and proceeds to block 404 which provides for monitoring content of one or more messages. At block 406, the method 400 provides for identifying personal information of the content of the one or more messages. Block 408 provides for receiving risk analytics information associated with the content of the one or more messages. At block 410, the method 400 provides for correlating the identified personal information and the risk analytics information. Block 412 provides for calculating a vulnerability score based on the correlation. Block 414 provides for transmitting a notification to a user, wherein the notification comprises the vulnerability score. The method 400 ends at block 416.

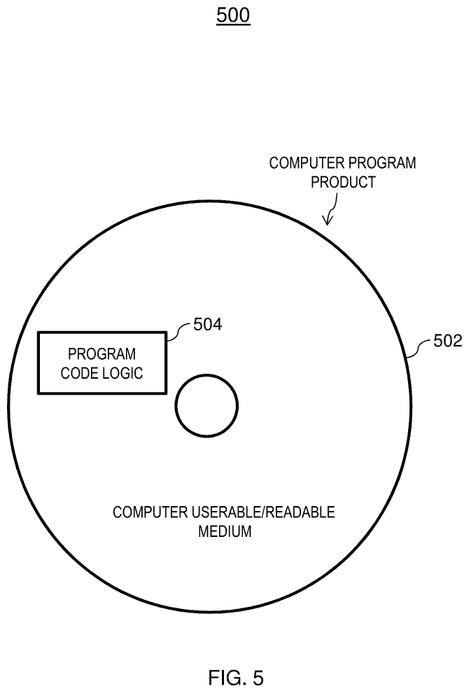

Referring now to FIG. 5, a computer program product 500 in accordance with an embodiment that includes a computer-readable storage medium 502 and program instructions 504 is generally shown.

The technical effects and benefits improve over the prior art by building trust and user confidence among the various social media groups. The technical effects and benefits improve over the prior art by monitoring and detecting potential vulnerabilities of social media users.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for social post management based on security considerations comprising:
monitoring content of one or more messages of at least one social media platform;
identifying personal information from the content of the one or more messages;
receiving risk analytics information associated with the content of the one or more messages;
correlating the identified personal information and the risk analytics information;
calculating a vulnerability score based on the correlation of the identified personal information and the risk analytics information; and
transmitting a notification to a user, the notification comprises the vulnerability score.

2. The computer-implemented method of claim 1, wherein the notification is transmitted to the user based at least in part on a configurable threshold for the vulnerability score.

3. The computer-implemented method of claim 1, wherein the personal information comprises location information and time information related to the location information associated with the user.

4. The computer-implemented method of claim 1, wherein the risk analytics information comprises at least one of a risk event, location information for an occurrence of the risk event, a risk score for the risk event, or risk factors associated with the risk event.

5. The computer-implemented method of claim 4, wherein the notification comprises the vulnerability score and the risk event, wherein the notification is provided to a user including at least one of an audio notification, visual notification, or haptic feedback that is based at least in part on the vulnerability score.

6. The computer-implemented method of claim 1, wherein identifying personal information comprises determining contextual reference information, wherein the contextual reference information is based on personal information of a first message and personal information of one or more subsequent messages.

7. The computer-implemented method of claim 6, wherein identifying the personal information is identified from a plurality of messages from a plurality of social media platforms.

8. The computer-implemented method of claim 2, further comprising determining a travel route based on the personal information of a first message and a personal information of the one or more subsequent messages;
correlating one or more locations of the travel route to the risk analytics information; and
calculating the vulnerability score based on the correlation of the one or more locations to the risk analytics information; and
transmitting a notification to the user responsive to exceeding the configurable threshold for the vulnerability score.

9. The computer-implemented method of claim 1, further comprising:
determining an update on risk analytics for one or more existing posts associated with the user;
re-calculating a vulnerability score based at least in part on the update;
automatically hiding the one or more existing posts based at least in part on the vulnerability score; and
transmitting a notification to the user.

10. The computer-implemented method of claim 1, further comprising:
determining personal information of a post shared by another user;
calculating a vulnerability score for the post shared by another user;
notifying the user of the post shared by another user; and
taking an action for the post shared by another user, responsive to the user.

11. A computer program product for social post management based on security considerations, the computer program product comprising:
a computer-readable storage medium having stored thereon program instructions executable by a processor, wherein the program instructions cause the processor to:
monitor content of one or more messages of at least one social media platform;
identify personal information from the content of the one or more messages;
receive risk analytics information associated with the content of the one or more messages;
correlate the identified personal information and the risk analytics information;
calculate a vulnerability score based on the correlation of the identified personal information and the risk analytics information; and
transmit a notification to a user, the notification comprises the vulnerability score.

12. The computer program product of claim 11, wherein the personal information the one or more messages comprises location information and time information related to the location information associated with the user.

13. The computer program product of claim 11, wherein the risk analytics information comprises at least one of a risk event, location information for an occurrence of the risk event, a risk score for the risk event, or risk factors associated with the risk event.

14. The computer program product of claim 11, wherein identifying personal information comprises determining contextual reference information, wherein the contextual reference information is based on personal information of a first message and personal information of one or more subsequent messages.

15. The computer program product of claim 12, wherein the instructions are further executable by the processor to cause the processor to determine a travel route based on the personal information of a first message and the personal information of one or more subsequent messages;
correlate one or more locations of the travel route to the risk analytics information; and
calculate the vulnerability score based on the correlation of the one or more locations to the risk analytics information; and
transmit a notification to the user responsive to exceeding the configurable threshold for the vulnerability score.

16. The computer program product of claim 11, wherein the instructions are further executable by the processor to cause the processor to determine an update on risk analytics for one or more existing posts associated with the user;
re-calculate a vulnerability score based at least in part on the update;
automatically hide the one or more existing posts based at least in part on the vulnerability score; and
transmit a notification to the user.

17. The computer program product of claim 11, wherein the instructions are further executable by the processor to cause the processor to determine personal information of a post shared by another user;
calculate a vulnerability score for the post shared by another user;
notify the user of the post shared by another user; and
take an action for the post shared by another user, responsive to the user.

18. A system for social post management based on security considerations, the system comprising:
a vulnerability score engine;
a pre-post warning component;
a storage medium, the storage medium being coupled to a processor;
the processor configured to:
monitor content of one or more messages of at least one social media platform;
identify personal information from the content of the one or more messages;
receive risk analytics information associated with the content of the one or more messages;
correlate the identified personal information and the risk analytics information;
calculate a vulnerability score based on the correlation of the identified personal information and the risk analytics information; and
transmit a notification to a user, the notification comprises the vulnerability score based at least in part on a configurable threshold for the vulnerability score.

19. The system of claim 18, wherein the processor is configured to determine a route based on the personal information of a first message and the personal information of one or more subsequent messages;
correlate one or more locations of the route to the risk analytics information; and
calculate the vulnerability score based on the correlation of the one or more locations to the risk analytics information; and
transmit a notification to the user responsive to exceeding the configurable threshold for the vulnerability score.

20. The system of claim 18, wherein the processor is configured to determine an update on risk analytics for one or more existing posts associated with the user;
re-calculate a vulnerability score based at least in part on the update;
automatically hide the one or more existing posts based at least in part on the vulnerability score; and
transmit a notification to the user; and
wherein the processor is configured to determine personal information of a post shared by another user;
calculate a vulnerability score for the post shared by another user;
notify the user of the post shared by another user; and
take an action for the post shared by another user, responsive to the user.
